(19) United States
(12) Patent Application Publication
(10) Pub. No.: US 2012/0019429 A1
(43) Pub. Date: Jan. 26, 2012

(54) Pivotal Wireless Transmission Device

(75) Inventors: Tsung-Wen Chiu, Taipei County (TW); Fu Ren Hsiao, Taipei County (TW)

(73) Assignee: ADVANCED CONNECTEK, INC., Taipei County (TW)

(21) Appl. No.: 12/972,935

(22) Filed: Dec. 20, 2010

(30) Foreign Application Priority Data
Jul. 23, 2010 (TW) 099124290

(51) Int. Cl. H01Q 3/02

(52) U.S. Cl. 343/882

(57) ABSTRACT

A pivotal wireless transmission device comprises a fixing device having a first plane, a second plane and a coupling member coupling the first plane and the second plane; and a radiation conductor having a conduction path extending from one side of the first plane and a feeder point arranged in the conduction path. The present invention enables the radiation conductor to be securely fixed to a display frame. The present invention uses the first plane as the ground plane of the radiation conductor. Thus, both the first plane and the second plane function as the ground planes of the antenna system. Thereby is increased the transmission efficiency of radiation signals.

### BACKGROUND OF THE INVENTION

1. Field of the Invention

The present invention relates to a pivotal wireless transmission device, particularly to a device wherein wireless transmission elements are integrated with a pivotal device able to open or close an electronic device.

2. Description of the Related Art

Wireless communication products, such as portable computers, mobile phones, vehicle navigation devices, etc., have played an important role in our daily life. Wireless communication products rely on antennae to receive and transmit wireless signals.

The performance of an antenna correlates with the gain thereof. How to effectively arrange antenna elements inside an electronic product and promote the transmission efficiency is a critical subject in antenna design. Many electronic products have a pivotal design. When the radiation conductor is arranged at the border of the housing, the neighboring operation interface is likely to interfere with the radiation signals, which results in nulls in the radiation pattern, decreases the gain, reduces the signal intensity and lowers the transmission efficiency. Therefore, how to simultaneously increase the near-pivot signal intensity and achieve a high gain has been a problem the manufacturers desire to overcome.

### SUMMARY OF THE INVENTION

The primary objective of the present invention is to provide a pivotal wireless transmission device, which uses a fixing device to securely fix a radiation conductor to a display frame to prevent from noise and nulls of radiation signals, whereby the gain and signal intensity is increased, and whereby the efficiency and stability of signal transmission is improved.

Another objective of the present invention is to provide a pivotal wireless transmission device, wherein a first plane of the fixing device is used as the ground plane of the radiation conductor, whereby both the first plane and the second plane function as the ground planes of the radiation conductor, and whereby the interference from external objects is reduced, and whereby the radiation pattern of the antenna is improved, and whereby the operational frequency band and transmission efficiency is increased.

To achieve the abovementioned objectives, the present invention proposes a pivotal wireless transmission device, which comprises a fixing device having a first plane, a second plane device and a coupling member; and a radiation conductor extending from one side of the first plane, whereby the radiation conductor is securely fixed to a display frame, and whereby the noise of radiation signals is reduced, and whereby the gain and signal intensity is increased, and whereby the efficiency and stability of signal transmission is improved. The fixing device is made of a metallic material. The second plane is electrically connected with the first plane and the bottom frame of the wireless transmission device. Therefore, the second plane and the bottom frame also function as the ground planes of the antenna module. Thus is increased the radiation area of the antenna module and decreased the interference of radiation signals. As a result, the present invention improves the radiation pattern, increases the operational frequency bands, raises the radiation intensity, and promotes the transmission efficiency.

Below, the embodiments are described in detail to make easily understood the technical contents of the present invention.

### BRIEF DESCRIPTION OF THE DRAWINGS

FIG. 1 is a perspective view schematically showing a pivotal wireless transmission device according to a first embodiment of the present invention;

FIG. 2 is a top view schematically showing the pivotal wireless transmission device according to the first embodiment of the present invention;

FIG. 3 is a perspective view schematically showing a pivotal wireless transmission device according to a second embodiment of the present invention;

FIG. 4 is a diagram showing the measurement results of the voltage standing wave ratio of the pivotal wireless transmission device according to the second embodiment of the present invention; and

FIG. 5 is a partially-enlarged perspective view showing that the pivotal wireless transmission device according to the second embodiment of the present invention is applied to a portable computer.

### DETAILED DESCRIPTION OF THE INVENTION

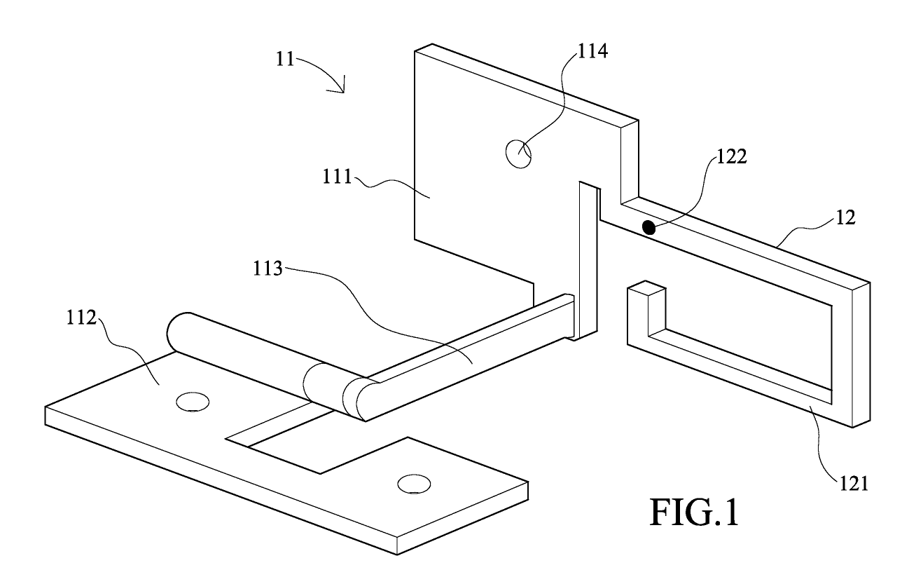

Refer to FIG. 1 a perspective view schematically showing a pivotal wireless transmission device according to a first embodiment of the present invention. The device of the present invention comprises a fixing device 11 and a radiation conductor 12. The fixing device 11 is a hinge. The fixing device 11 has a first plane 111, a second plane 112 and a coupling member 113. The coupling member 113 couples the first plane 111 and the second plane 112. A plurality of fixing holes 114 is formed in the fixing device 11 and used to fix the fixing device 11 and the radiation conductor 12 to an edge of a display frame. The coupling member 113 has a rotation bearing, whereby the first plane 111 and the second plane 112 can be rotated with respect to each other, and whereby the wireless transmission apparatus can be opened or closed. The radiation conductor 12 has a conduction path 121 extending from one side of the first plane 111. The conduction path 121 has a feeder point 122. The terminal of the conduction path 121 is in an open-loop state. The conduction path 121 has a length of about one-fourth the wavelength of the signal having the antenna resonance frequency. The first plane 111 functions as the ground plane of the radiation conductor 12 in the integration design of the fixing device 11 and the radiation conductor 12 of the present invention.

In one embodiment, the radiation conductor 12 is hollow and has a loop-like shape. The radiation conductor 12 has four straight segments. The first straight segment is connected with the first plane 111 and has a length of about 15 mm and a width of about 2 mm. The second straight segment has a length of about 6 mm and a width of about 2 mm. The third straight segment has a length of about 11 mm and a width of about 2 mm. The fourth straight segment is the terminal segment and has a length of about 2 mm and a width of about 2 mm. The radiation conductor 12 has a thickness of about 2 mm. The first plane 111 has a rectangular shape. The first plane 111 has a length of about 26 mm and a width of about 22 mm. The coupling member 113 has a shape of a rectangular bar. The coupling member 113 has a length of about 20 mm, a width of about 3 mm and a thickness of about 2 mm. The second plane 112 has a rectangular shape. The second plane has a total length of about 40 mm and a total width of about 15 mm. The second plane 12 has two square regions with the fixing holes and a hollow rectangular area. Each of the two square regions has a length of about 15 mm. The hollow rectangular area has a length of about 10 mm and a width of about 5 mm.

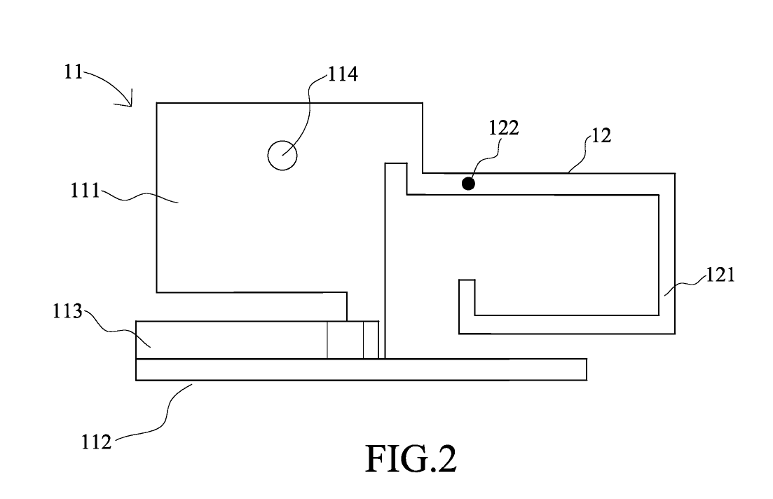

Refer to FIG. 2 a top view schematically showing the pivotal wireless transmission device according to the first embodiment of the present invention. The first plane 111 and the radiation conductor 12 are coplanar and can be stuck to the surface of the display frame smooth and flatly, whereby the radiation conductor 12 would not be warped or distorted. Thus is guaranteed the transmission efficiency of radiation signals.

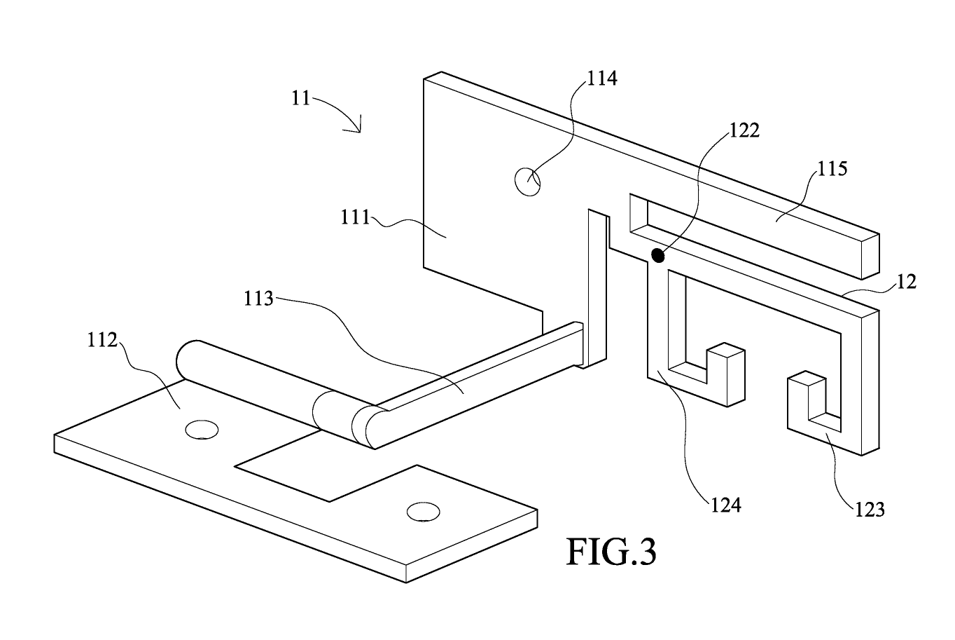

Refer to FIG. 3 a perspective view schematically showing a pivotal wireless transmission device according to a second embodiment of the present invention. The second embodiment is basically similar to the first embodiment. The second embodiment is different from the first embodiment in that the radiation conductor 12 has a first conduction path 123 and a second conduction path 124 both extending from one side of the first plane 111. The feeder point 122 is arranged in a connection interface of the first conduction path 123 and the second conduction path 124. The first plane 111 has an extension section 115 extending from the first plane 111 and neighboring the radiation conductor 12 to increase the sticking area of the first plane 111 and enhance the strength of the fixing device 11. In the present invention, the integration design of the fixing device 11 and the radiation conductor 12 not only can guarantee the security of the radiation conductor 12 but also may have serpentine conduction paths to increase the operation bandwidth and applicable frequency bands.

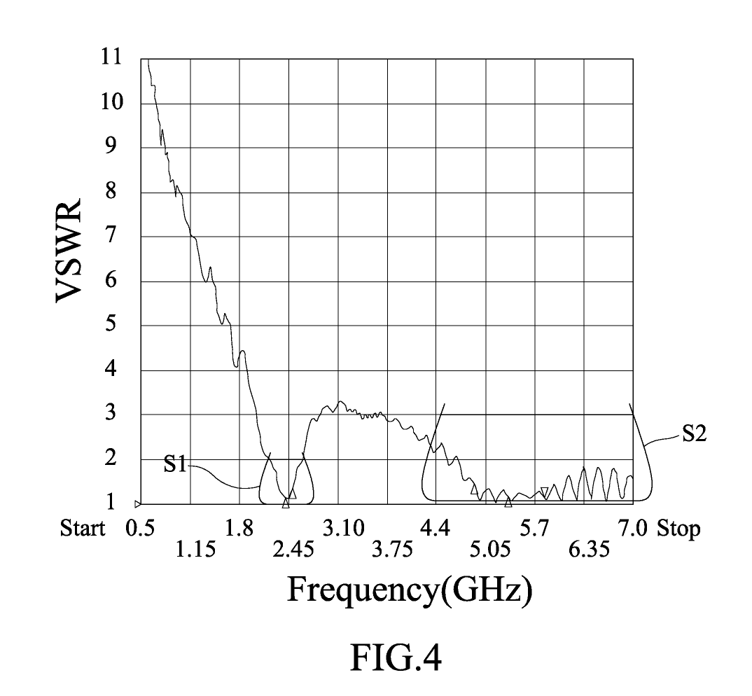

Refer to FIG. 4 a diagram showing the measurement results of the voltage standing wave ratio (VSWR) of the pivotal wireless transmission device according to the second embodiment of the present invention. The diagram shows VSWR variation in an operational frequency band S1 (2.4-2.5 GHz) and an operational frequency band S2 (4.9-5.825 GHz). In normal standards, an antenna would not satisfy the performance requirements unless VSWR is smaller than 3. FIG. 4 shows that all the operational frequency bands are below the VSWR value 3, and that most of the operational frequency bands are below the VSWR value 2. Therefore, the present invention can greatly increase the operational frequency bands.

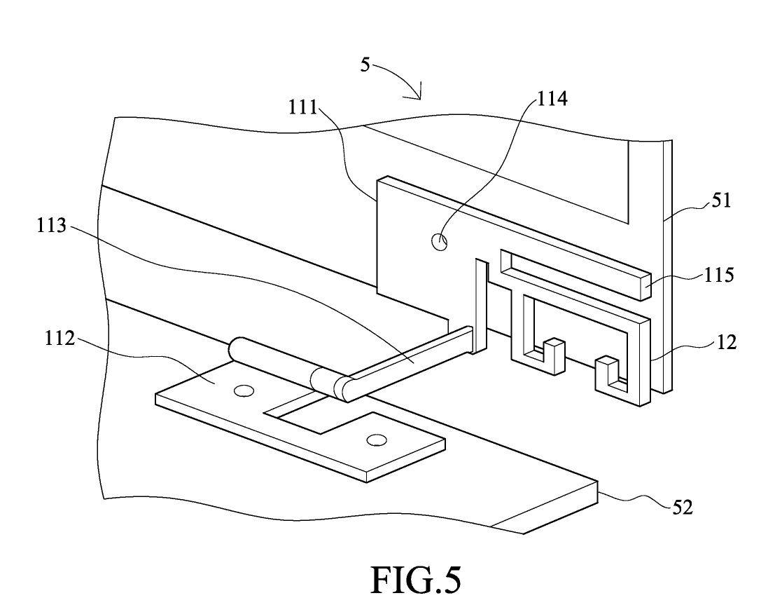

Refer to FIG. 5 a partially-enlarged perspective view showing that the pivotal wireless transmission device according to the second embodiment is applied to a portable computer. Via the fixing holes 114, the fixing device 11 and the radiation conductor 12 are fixed to a display frame 51 of a portable computer 5, and the second plane 112 is fixed to the lower casing 52 of the portable computer 5. As the coupling member 113 has a rotation bearing, the first plane 111 and the second plane 112 can be rotated with respect to each other to open or close the portable computer 5.

The present invention possesses utility, novelty and non-obviousness and meets the conditions for a patent. However, it should be noted that the embodiments described above are only to exemplify the present invention but not to limit the scope of the present invention. Therefore, any equivalent modification or variation according to the spirit of the present invention is to be also included within the scope of the present invention.

What is claimed is:

1. A pivotal wireless transmission device comprising
a fixing device having a first plane, a second plane and a coupling member coupling said first plane and said second plane; and
a radiation conductor extending from one side of said first plane and having a feeder point.

2. The pivotal wireless transmission device according to claim 1, wherein said fixing device is a hinge.

3. The pivotal wireless transmission device according to claim 1, wherein a plurality of fixing holes is formed in said fixing device.

4. The pivotal wireless transmission device according to claim 1, wherein said first plane is a ground plane of said radiation conductor.

5. The pivotal wireless transmission device according to claim 1, wherein said coupling member has a rotation bearing.

6. The pivotal wireless transmission device according to claim 1, wherein said first plane and said radiation conductor are coplanar.

7. The pivotal wireless transmission device according to claim 1, wherein said radiation conductor has a conduction path extending from one side of said first plane, and wherein said a terminal of said conduction path is in an open-loop state.

8. The pivotal wireless transmission device according to claim 7, wherein said conduction path has a length of about one-fourth the wavelength of a signal having an antenna resonance frequency.

9. The pivotal wireless transmission device according to claim 1, wherein said first plane has an extension section extending from said first plane and neighboring said radiation conductor.
